(19) United States
(12) Patent Application Publication
(10) Pub. No.: US 2026/0241738 A1
(43) Pub. Date: Aug. 20, 2026

(54) Machine for the Adhesive Binding of a Book Block

(71) Applicant: Müller Martini Holding AG, CH-6052 Hergiswil (CH)

(72) Inventor: Gérard Baumgartner, Luzern (CH)

(73) Assignee: Müller Martini Holding AG, CH-6052 Hergiswil (CH)

(21) Appl. No.: 19/546,230

(22) Filed: Feb. 20, 2026

(30) Foreign Application Priority Data
Feb. 20, 2025 (DE) 102025106559.4

(51) Int. Cl. B42C 19/08; B42C 9/00

(52) U.S. Cl. CPC B42C 19/08; B42C 9/00

(57) ABSTRACT

The invention relates to a machine for adhesively binding a book block. After adhesive is applied to the spine, a book block transport system transports the book block, held inside a transport clamp, to a removal station where the processed book block is removed from the transport clamp. Removal occurs employing a conveying device which deflects the book block over the course of a conveying section. The conveying device includes a first conveying means which removes the processed book block with a controlled movement from the transport clamp. The first conveying means is followed by a second conveying means that includes a shifting device and a swivel-driven supporting device which takes over the processed book block from the first conveying means, deflects the book block from the approximately vertical orientation to an approximately horizontal orientation, and transfers it to a following conveying element.

### CROSS-REFERENCE TO RELATED APPLICATIONS

This application is a U.S. counterpart of German application No. 102025106559.4 filed in Germany on Feb. 20, 2025, the priority of which is claimed in the present application, and the content of which is incorporated herein by reference.

### BACKGROUND

The present invention relates to a machine for the adhesive binding of a book block, comprising at least one station for processing a book block spine and at least one device for applying adhesive to the spine. With a book block transporting system, the book blocks are transported along the processing stations through the machine, while oriented at least approximately vertical. The book block transporting system comprises an intake station for holding an unbound book block inside a transport clamp, as well as a removal station for removing the processed book block from the transport clamp, wherein the processed book block is removed from the transport clamp via a conveying device which changes the orientation of the processed book block over the course of a conveying section with the aid of a deflection means from the approximately vertical orientation to an approximately horizontal orientation. The machine furthermore comprises an electronic control device for controlling the machine functions.

A generic machine of this type is known from German patent document DE 102012023370A1. With this perfect binding machine, a collated book block is held inside a transport clamp. During the transport of the book block from the intake station to the removal station, the spine of the unbound book block is processed by chamfering the joints of the individual book block sheets. If necessary, the spine is additionally notched. The adhesive is then applied to the book spine and the book sides. Depending on the desired binding quality and the processing condition of the book spine, either a PUR adhesive or a hotmelt can be used for the adhesive. Following this, a reinforcing strip or wrapper is attached to the book block. At the removal station, the processed book block provided with a reinforcing strip and/or a wrapper is removed from the transport clamp and is conveyed further. The book block is subsequently supplied to further processing stations. The book block can be removed from the transport clamp, in particular with the aid of gripper fingers in downward direction, with the spine pointing ahead, when the book block is transported through the adhesive binder while held in the upright position by the transport clamp.

During the removal of the book block from the transport clamp, the adhesive used for the binding may not have hardened completely. The risk therefore exists that the pages of the book can shift relative to each other when the book block is removed from the transport clamp. To avoid a shifting, gripper fingers are placed with increased pressure onto the book block. However, the gripper fingers can leave imprints on the book block because of the high pressure. The pages of a book block can also shift when the book block is deflected following the removal from the transport clamp. The book block is then no longer transported standing on its spine, but resting on one of its flat sides, with the spine pointing ahead, so as to be suitably aligned for a subsequent processing. Deflection wheels can be used for the deflecting which, however, must have a comparatively large diameter to avoid a shifting of the pages of a book block and a deformation of the book block during the deflection operation. Finally, the technology for removing a book block from the transport clamp also limits the operating speed of the perfect binder on the whole since the operating speed of the removal elements cannot be increased by simply increasing the movement speed due to the increased risk of deformed book blocks.

### SUMMARY OF THE INVENTION

It is an object of the present invention to improve the removal of a book block from a transport clamp.

The above and other objects are solved for a generic machine in that the conveying device comprises a first conveying means which removes a processed book block with a controlled movement from the transport clamp, and in that a second conveying means is arranged downstream of the first conveying means which takes over the processed book block from the first conveying means, deflects it from an approximately vertical position to an approximately horizontal position and transfers it to a following conveying means, wherein the second conveying means is provided with a deflection element and a swivel-driven supporting device.

More specifically, the machine is provided with a first conveying means which removes a processed book block with a controlled movement from the transport clamp. In particular, the first conveying means can be composed of several machine elements of which at least one machine element is driven. The first conveying means in particular can comprise movable pressing jaws or grippers which grip the book block with a controlled feed movement. The pressure exerted by the conveying means for gripping the book block is selected such that the book block is held securely and cannot deform in an undesirable manner, even during the subsequent conveying movement. The conveying means is then moved by a drive means along a conveying section during which the book block is removed from the transport clamp and conveyed away.

Arranged downstream of the first conveying means is a second conveying means which takes over the processed book block from the first conveying means. The second conveying means is designed and arranged such that it securely takes over the book block conveyed by the first conveying means, without deforming the book block, and conveys it further. The movements of the first and second conveying means are appropriately coordinated for this.

The second conveying means is suitably designed. In particular, the second conveying means can be composed of several machine elements of which at least one machine element is driven. The second conveying means deflects the processed book block from an at least approximately vertical to an at least approximately horizontal position and transfers it to a downstream conveying element. For this, the second conveying means is driven with aid of a drive means along a conveying section, on which the book block is reoriented in a desired manner to a spatial orientation necessary for transferring the book block to a downstream arranged conveying means or a downstream arranged processing station.

By distributing to several elements the function of the conveying device for removing a book block from a transport clamp and conveying it away, in particular to a first and second conveying means, the processing time can be shortened for removing the book block from the transport clamp. Since the respective conveying means only needs to carry out shorter movement cycles, it is theoretically possible with optimum coordination of the two conveying devices to reduce by half the processing time for removing a book spine from the transport clamp. The first conveying means can thus return to its starting position for gripping a new book block while the second conveying means is still transporting the book block previously removed from the transport clamp in the direction of a following conveying element. In particular, the cycle time for the perfect binder on the whole is shortened and its operating speed increased if the conveying device is the output limiting factor. In addition to shortening the cycle time, the distribution of the removal operation to two conveying means, makes it easier for these to be adapted to the respective conveying task, thereby increasing the operating quality of the perfect binder.

The first conveying means can therefore be optimized specifically for the removal of the book block from the transport clamp while the second conveying means can be optimized specifically for the deflecting of the book block and its transfer to a downstream conveying means or a downstream processing station. The first conveying means can be optimized, for example, in that the conveying process need not be considered when designing the travel distances and the conveying movements of the removal means, such as a pair of pressing jaws, and for the design of the conveying means, since the conveying process is now covered by the second conveying means. Optimizing the second conveying means is possible, for example, by accelerating or reducing the movement speed of the book block along the conveying section for the second conveying means or the movement path, or the movement path and/or the second conveying means itself are optimized in such a way as to reduce the risk of an undesirable deformation of the book block or the book spine during the transport.

In order to optimize the first and the second conveying means, these can respectively be provided with a separate drive which permits different control times and rotational speeds. Different types of drives can furthermore be used, for example servomotors, linear motors, actuating cylinders, and the like. By uncoupling the drives, the conveying means can realize process-optimized movements without being dependent on the movements respectively carried out by the other conveying means which also reduces the risk that the book block with the freshly applied and possibly not yet completely hardened adhesive on the book spine could still be deformed in an undesirable manner. Whereas the first conveying means especially can be designed to perform only a movement for removing a book block from the transport clamp with an approximately linear movement, the second conveying means in particular can be designed to supply the book block along a curved track to a downstream conveying means or a downstream processing station, wherein the book block in the process can also be deflected if necessary. The second conveying means can rotate around a fixed fulcrum. However, it is also possible to control the second conveying means so as to move via a forced guidance along a predetermined movement track which does not necessarily correspond to a circular track.

According to one embodiment of the invention, the conveying device comprises as a first conveying means at least a pair of pressing jaws, arranged on opposite sides of a book block to be processed, of which at least one pressing jaw is driven movably in a first direction so that it can fit itself in the removal station from a holding position against the side of the book block to be processed, in the area of the spine, wherein the pressing jaws can be adjusted with an adjustment device to move in a second direction, so as to convey in downward direction the book block clamped into the pressing jaws. The movement of one or several pressing jaws in the first direction therefore serves the purpose of gripping the book block to be conveyed and to secure it between the pressing jaws. In particular, the first direction in which the pressing jaws are movable is transverse to the transporting direction of the transport clamp and oriented in an approximately horizontal direction if the book blocks are transported in the transport clamps while approximately vertically oriented. Pneumatic cylinders, linear motors, rotary motors or comparable drives, for example, can be used as drives for adjusting the pressing jaws. With the feed movement of the drives, a book block is gripped and pressed. The pressing jaws can be fitted especially in the spinal area against the front and back sides of the book block. So as not to disturb the process of fitting the pressing jaws against the book block and the removal of the book block from the transport clamps, the transport clamp can be stopped briefly in the region of the removal station.

Once the pressing jaws are fitted against the book block, the transport clamp can be opened and the pressing jaws then moved with a shifting device in a second direction to convey the book block, held by the pressing jaws, out of the transport clamp. During this conveying movement, the opened transport clamp can start up again and move back into the region of the intake station to pick up a new book block.

According to one embodiment of the invention, the pressure exerted by the at least one movable pressing jaw onto the side of the processed book block facing said pressing jaw is optionally adjustable and/or can be adjusted during a conveying movement. Depending on the thickness of the book block and the paper used for the book block, it may be advantageous if the pressing jaws exert a higher or lower pressure onto the book block. The pressure should not be too high to avoid leaving impression marks on the book block. However, if the pressure is too low, the risk exists that that the book block moves relative to the pressing jaws, is deformed during the removal, or disintegrates completely. Thus, the pressure can also not be too low. The required pressure can also vary during the removal process. With a variable pressure over an operating cycle, it is possible to control the pressure as needed and keep it as low as possible.

According to one embodiment of the invention, the pressing jaws extend lengthwise over the complete spinal length of the processed book block. Owing to this design, the book block can be compressed evenly over its complete spinal length. Together with the adhesive applied to the book spine, this results in a straight edge shape of the book block in the spinal region, without resulting in wavy deformations of the book spine through sections that are compressed and sections that are not compressed. The larger surface for distributing the pressure exerted by the pressing jaws onto the book block furthermore reduces the risk of the pressing jaws leaving impressions on the front and/or back of the book block. The pressing jaws are at least as long as the maximum spine length of the book block to be processed by the perfect binding machine.

According to one embodiment of the invention, the adjusting device is designed as a vertically adjustable table, with the pressing jaws attached thereto. With the aid of respective drives, the table can be easily adjusted in height between an upper receiving position and a lower delivery position in order to remove a book block, held by the pressing jaws, in downward direction from the transport clamp. Pneumatic cylinders, spindle drives, linear motors, rotating motors or comparable drives can be used for the drives. The table at the same time also provides good fastening options for the pressing jaws and their drives, which are moved along during a height adjustment of the table.

According to one embodiment of the invention, the table is provided with guide elements positioned inside guide rails which are mounted on the machine frame. The guide rails predetermine an adjustment track along which the table can move. The table is moved up and down along this adjustment track with the guide elements. The table and its guide elements are moved with a drive motor. The drive motor can be connected to the electronic control device which issues the commands for the respective movement to be carried out to the drive motor via a suitable software.

According to one embodiment of the invention, the deflection element is embodied as a curved slide, which transitions as seen in conveying direction from an at least approximately vertical to an at least approximately horizontal course. The top of the slide surface that faces the book block is advantageously composed of a material with low frictional resistance, so that the book block is not deformed by braking resistance caused by friction on the side of the slide facing the book block when the book block glides over the surface. The slide can be embodied, for example, as a continuous metal sheet, a number of spaced apart bars, arranged parallel to each other, a roller track or a pneumatic table. The curved shape of the slide should have a radius of at least 250 mm, so that a book block is not deformed when passing through the slide in such a way that the book block spine is subsequently no longer oriented at a right angle to the side surfaces. For example, the curved shape of the slide can cover approximately a fourth of a circle to maneuver a book block from a vertical spatial position to a horizontal position where a book block is positioned on one of its flat sides. The slide guides a book block in conveying direction, with its spine positioned in the lead, while it passes through the conveying section covered by the second conveying means. A book block being transferred from the first conveying means to the second conveying means can move away further from the transport clamp in a fluid gravitational movement and following the curved form of the slide and can move toward a following processing station. After the first conveying means has released the book block at the end of the conveying section covered by the first conveying means and has transferred it to the second conveying means, the first conveying means can be moved back to the starting position for an operating cycle to remove the next book block from the transport clamp during the following operating cycle.

According to one embodiment of the invention, the swivel-driven supporting device has a supporting surface which carries out a swiveling movement following the slide movement during an operating cycle, as a result of which the spine of a processed book block rests at least at times on or against the supporting surface during the passage of the second conveying means. If the processed book spine with the not completely hardened adhesive, which is positioned in an at least approximately vertical orientation, is transferred from the first conveying means to the second conveying means while being supported on a supporting surface, the pages of the book block maintain their position relative to each other even after the release of the book block by the first conveying means because they are prevented by the supporting surface from moving relative to each other. Owing to the effect of gravity, the pages of the book block are held evenly pressed against the supporting surface, so that no relative forces in vertical direction can be generated between the individual pages of the book block during the book block transport on the supporting surface of the supporting device. Owing to the planar contact of the adhesive-covered book spine with the supporting surface, the cooling down and hardening of the adhesive is accelerated in this region because the supporting surface material absorbs heat from the adhesive, thereby cooling the adhesive and causing it to harden faster. The book block thus obtains a sufficiently solid form faster, which cannot be changed any longer by conveying means and conveying operations. If we refer to a supporting device here, it must not be understood as a quantifier but as an indefinite article. The above described function of a supporting device can also be met over the course of the conveying section by several supporting devices, moving side-by-side or successively, which can have a joint drive or respectively individual drives.

The supporting device then carries out a swiveling movement that follows the course of the slide. During this swiveling movement the supporting device also prevents a deformation of the book block with the aid of the supporting surface. During the course of the swiveling movement of the supporting device and the removal of the book block along a curved section, the pages of the book block continue to be supported by the supporting surface since the supporting surface in particular continues to maintain an at least approximately uniform parallel orientation relative to the surface of the book spine. It is advantageous if the curved shape of the slide and the course of the swiveling movement of the supporting surface are designed such that the supporting surface follows at least approximately the curved course of the slide during the swiveling movement. If the supporting surface maintains an at least approximately constant distance to the slide during the swiveling movement, relative movements are avoided between the book block guided by the slide and the book spine supported by the supporting surface. In the region of the second conveying means, the polymers in the adhesive can thus crosslink undisturbed during the cooling of the adhesive, without this causing undesirable tensions in the material. The swiveling movement of the supporting surface is advantageously designed such that the spine of a book block is supported flat by the supporting surface during the course of the swiveling movement when passing through the conveying section covered by the second conveying means. Owing to the parallel orientation of the supporting surface and the book spine along the conveying section for the second conveying means, which is maintained during the swiveling movement, tensile forces between the pages of the book block are also avoided which take the form of shear stresses and could develop if the book block were to make contact only with a portion of its width over the supporting surface. Since the development of shear stresses in the book block is prevented by the parallel guidance of the supporting surface, relative to the course of the slide, an undesirable deformation of the book block is prevented during the course of the conveying section traversed by the second conveying means, even if the orientation of the book block changes from upright to horizontal during the passage of the conveying section covered by the second conveying means.

The function of the supporting surface here must be viewed in connection with the function of the deflection element. The supporting element and the deflection element advantageously complement each other. Since the deflection element deflections a book block over the course of the conveying section from an approximately vertical orientation to an approximately horizontal orientation, only the deflection element is assigned the function to deflect the movement direction of the book block from the at least approximately vertical dropping direction to an at least approximately horizontal movement direction. The supporting element in this case only functions to support the book block in conveying direction over the course of the conveying section for the second conveying means, to reorient it relative to the conveying direction and, in the process, to control and equalize the book block movement.

The first conveying means releases a book block which it has removed from the transport clamp once the book block reaches the supporting device with its spine. For this, the movements of the first conveying means and the supporting device can be controlled by the electronic control device in such a way that the first conveying means and the supporting device move at the same speed and in the same direction during a brief transfer moment. However, it is also possible that depending on the machine design, the first conveying means moves faster or slower in conveying direction than the supporting device at the instant when the first conveying means releases the book block.

The advantage of a supporting device carrying out a swiveling movement must be seen in that the supporting device need not bodily grip a book block to control and equalize its movement. A book block drops, so to speak, from the first conveying means onto the supporting surface, based solely on the effect of gravity and/or the movement pulse provided by the first conveying means to the book block, wherein during the initial contact the supporting surface suitably orients the book block in conveying direction as a result of its shape and spatial position. The impact of the book spine with the supporting surface achieves that the two flat sides of the book block are aligned or remain aligned at a right angle to the surface of the book spine. Separately driven and controlled grippers or pressing jaws on the supporting device can thus be omitted. Adjusting the perfect binder to different book formats is made easier because no format adjustments are needed at this point, and its production costs are kept low. The supporting device is consequently very light-weight, thus making it possible to keep at a controllable range the acceleration and deceleration moments, even with extremely fast movements, which occur during the movement of the supporting device during the machine operation. The light-weight design allows for the drives and bearings to be designed smaller and more cost-effective.

The swiveling movement along the slide only accounts for a portion of the movement distance traveled by the supporting device during an operating cycle. Once a book block has reached the end of the conveying section covered by the second conveying means, the supporting device is guided via a return movement back to the starting position for an operating cycle, so as to take over the next book block from the first conveying means during the following operating cycle. At the end of the conveying section, covered by the second conveying means, the supporting surface can detach from the book block in that the movement speed of the supporting surface is accelerated toward the end of the conveying section, the radius of the swiveling movement becomes smaller toward the inside, and/or the radius of the curve for the slide increases toward the end of the conveying section.

The supporting device can be driven with a constant speed during the swiveling movement. However, the movement speed of the supporting device can also vary during the time in which a book block passes through the conveying section covered by the second conveying means. For example, the supporting device can initially operate at a slower speed during the course of the swiveling movement, so that the book block is deposited with a jolt on the supporting surface. The speed can then be increased slightly to adapt the book block movement speed along the slide to the conveying speed of a following conveying element, and can subsequently be accelerated strongly so that the conveying surface detaches from the book spine at the end of the conveying section covered by the second conveying means. The supporting device remains long enough at a reversal point for the book block to be removed by the following conveying element from the movement range of the supporting device. The movement speed of the supporting device can be controlled and regulated by the electronic control device, using a suitable software, for each order or each individual book block.

According to one embodiment of the invention, the pressing jaws movement in the second direction is controlled by the control device in such a way that these deposit the processed book block onto the supporting surface of the supporting device. The supporting surface of the supporting device is oriented parallel to the spine surface of the processed book block when the processed book block is deposited by the pressing jaws onto the supporting surface. As described in the above, this design of the machine ensures that the book block does not get deformed undesirably during the transfer from the first to the second conveying means, even if the adhesive has not yet hardened.

According to one embodiment of the invention, the movement of the pressing jaws in the second direction is controlled by the control device in such a way that the spine of the processed book block comes to rest with a jolt on the supporting surface. By depositing the book block with a jolt on the supporting surface, the pages of the book block with the incompletely hardened adhesive can still align themselves such that the angularity of the book spine is improved in the process.

According to one embodiment of the invention, the supporting device is connected via a swiveling arm to a fulcrum, and the supporting surface carries out a circular-arc swiveling movement. The rotating movement of the supporting device around a fulcrum permits a quiet operation of the drive without noticeable accelerations and braking moments. Relative movements between the book block and the supporting surface can thus also be avoided in the best possible manner during the circular-arc movement.

According to one embodiment of the invention, the drive assigned to the supporting device is designed such that the supporting surface moves at the slide end in conveying direction with a movement speed that corresponds at least to the conveying speed of a conveying element following the slide in conveying direction. If the book block is released to the downstream arranged conveying element with a conveying speed that corresponds at least approximately to the speed at which the downstream conveying element moves, jerky movements of the book block during the transfer are avoided. The adhesive-coated book block in this way also preserves its angular shape, even during the transfer from the second conveying means to a downstream conveying element, and its orientation in conveying direction is maintained. With noticeably differing conveying speeds during the transfer, different frictional conditions between book block and conveying elements can lead to an undesirable turning of the book block and result in the leading book spine to be no longer oriented precisely transverse to the conveying direction.

According to one embodiment of the invention, the drive assigned to the supporting surface is embodied so as to accelerate the movement of the supporting surface in conveying direction, in the transfer region from the slide end as seen in conveying direction to a downstream arranged conveying element in conveying direction, to a value that is above the movement speed of the conveying element arranged downstream in conveying direction. As a result of accelerating the supporting surface in the transfer region, this surface detaches from the book spine without interfering with the uniform movement of the book block in the transition region.

According to one embodiment of the invention, the opening of the transport clamp in the removal station area and the movements of the first conveying means and the supporting device are coordinated in time by the control device, such that the transport clamp opens only once the first conveying means has been fitted against the processed book block, the processed book block is conveyed away with the first conveying means in downward direction only once the transport clamp is opened, and the first conveying means detaches itself from the processed book block only after the book block has been deposited on the supporting device. This control of the movements of the conveying means results in a shock-free and jerk-free movement of the book block which maintains the angularity of the book block during its transport, even though the applied adhesive has not yet hardened completely.

According to one embodiment of the invention, a sensor is connected in the region of the removal station to the control device, which monitors the removal of the book block from the transport clamp, wherein the control device switches the machine to “malfunction” if the sensor detects a faulty removal and reports it to the control device. The sensor can furthermore be designed to check whether or not the transport clamp contains a book block. With a faulty removal, the risk exists that the book block to be removed, or parts thereof, are still held in the transport clamp. To prevent the book block remaining in the transport clamp, or parts thereof, from colliding with the next book block to be picked up by the transport clamp at the intake station, the book block transport system can be stopped automatically in the malfunction mode. Operating personnel can then check the transport clamp and, if applicable, remove interfering remnants from the transport clamp.

According to one embodiment of the invention, a sensor is connected to the control device in the area of transition from the end of the deflection element in conveying direction to a following conveying element, or in the region of the conveying element following in conveying direction, which sensor monitors the conveying away of a respectively processed book block, wherein the control device switches the machine to “malfunction” if the sensor reports a faulty conveying away. To prevent that the book block or its remaining parts, which are still positioned in the area of the first or second conveying means, collide with the following book block to be conveyed by the first or second conveying means, the drives for the first and/or second conveying means and, if applicable, also the book block transport system can be stopped automatically in the malfunction mode. Operating personnel can then check the conveying section in the region of the first and second conveying means and, if applicable, remove interfering remainder from the conveying section. However, the sensor can additionally be designed to verify whether the book block passes the sensor at the expected point in time. Depending on its design, the sensor can also check the shape and/or position of the book block resting on the downstream transport element. If the sensor detects deviations from the expected target values, the control can interpret this as a reference to dirt on the slide and/or the supporting device or the supporting surface, caused by adhesive.

According to one embodiment of the invention, the control is programmed to move the first conveying means with the aid of an adjustment device back to its waiting position once the first conveying means has deposited the book block on the supporting device and has separated from the processed book block. The waiting position is the position occupied by the first conveying means and the adjustment device for gripping a new book block with a transport gripper, so that it can be conveyed away. The claimed control sequence ensures that the first conveying means operates precisely in time.

According to one embodiment of the invention, the control device is programmed to move the supporting device back to its starting position once a processed book block has been transferred to a conveying element arranged downstream of the second conveying means. The downstream arranged conveying element can be designed as a single conveying belt or several side-by-side arranged conveying belts, as a roller track with driven rollers, or as a conveying element provided with carriers or grippers. Owing to this control sequence, the supporting device can operate precisely in time.

### BRIEF DESCRIPTION OF THE DRAWINGS

Further advantages and details follow from the dependent claims and an exemplary embodiment shown in the drawings as follows:

FIG. 1: A schematic view from above of a machine according to the invenion;

FIG. 2: A further schematic view of the machine in FIG. 1 from the side; and

FIG. 3: A time/distance diagram showing the movements of the individual adjusting elements of the first and second conveying means.

### DETAILED DESCRIPTION

The representations essentially show a concrete exemplary embodiment. However, the invention is not restricted to the exemplary embodiment shown, but can be modified by an expert so as to adapt it to a specific use.

Insofar as it serves a purpose, matching components in all Figures are provided with identical reference numbers. For reasons of clarity, however, frequently occurring components are not always provided with reference numbers.

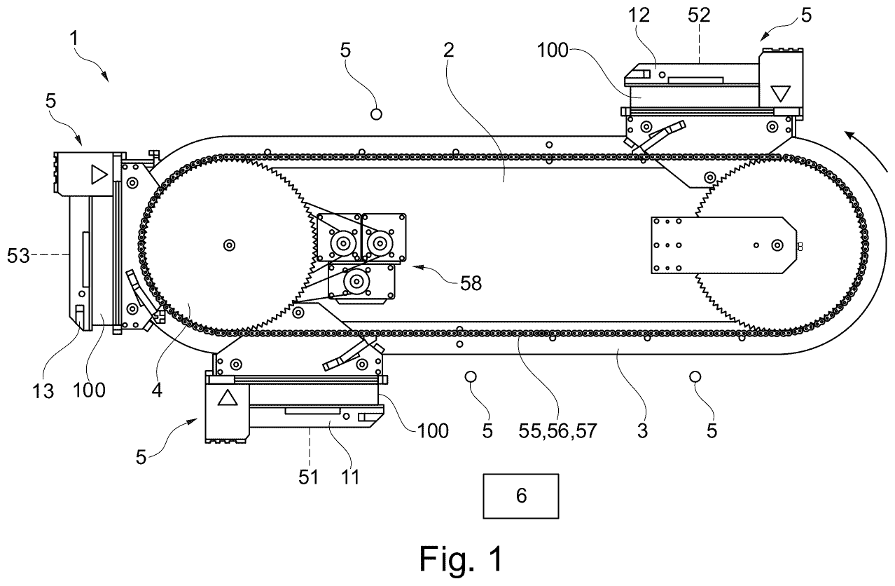

FIG. 1 shows a view from above of a machine 1 in the form of a perfect binder according to the invention, which is suitable for producing softcover books or book blocks for producing hardcover books. This machine 1 comprises a book block transport system 2 with a closed guide track 3 by means of which three transport grippers 11, 12, 13 are respectively moved with a guide arrangement attached to a machine frame 29 of the machine 1 through processing stations 5 which are arranged along the guide track 3. Mentioned here as example for such processing stations 5 are a block intake station, a spine processing station (milling cutter), an adhesive application device, a device for controlling the adhesive application, a station for supplying a cover and/or a reinforcing strip, 0 a station for pressing on the cover and/or reinforcing strip, a delivery station and a drying station.

This machine 1 is additionally provided with drives 58, wherein a first drive is assigned to a first transport clamp 11, a second drive to a second transport clamp 12, and a third drive to a third transport clamp 13. The drives 58 are respectively provided with a drive chain 55, 56, 57 to which the assigned transport clamp 11, 12, 13 is attached and which is driven by a separate drive motor via a chain sprocket 4. The drive motors in this case are actuated by a control device 6 of the machine 1. Speed profiles are recorded in the control device 6, so that the transport clamps 11, 12, 13 can be moved respectively with a separate speed profile along the guide section 3. Of course, a book block transport system 2 can also be used which is equipped with only two or with more than three transport clamps 11, 12, 13, as well as a corresponding number of drives.

The machine 1 has a number of stopping positions where a transport clamp 11, 12, 13 can respectively be stopped by its assigned drive. Shown, for example, is a first stopping position at an intake station 51 for inserting loose book blocks 100, a second stopping position 52 for pressing a non-depicted cover onto a book block 100, and a third stopping position at a removal station 53 for discharging book blocks 100 with a processed book spine 101. If a processing station 5 exists that is embodied as a station for attaching a reinforcing strip, a further stopping position is provided in that area. Differently long stopping times can be recorded in the control device 6 for the stopping positions 51, 52, 53.

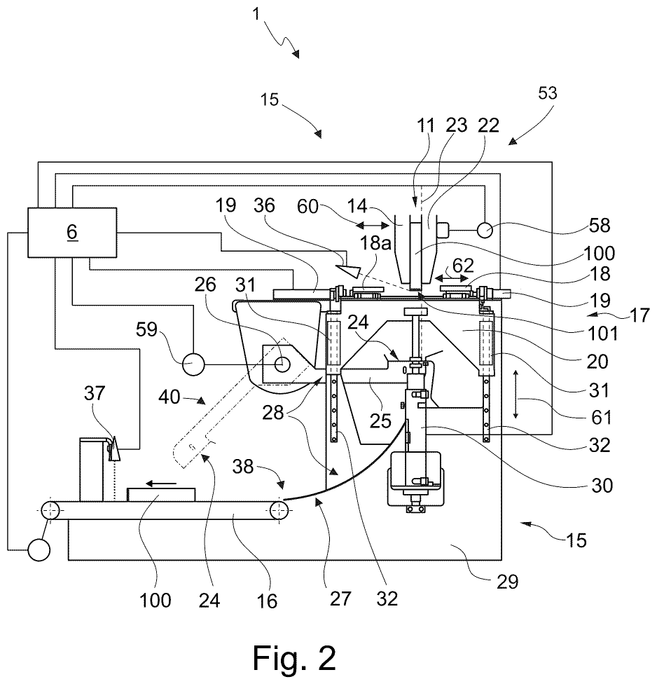

FIG. 2 shows another schematic representation of the machine 1. This representation shows a book block 100, held vertically aligned inside the transport clamp 11. For the exemplary embodiment shown, the transport clamp 11 comprises a movable clamp part 14 for which the movement direction is indicated with the double arrow 60, drawn in beside the transport clamp 11. If the movable clamp part 14 is detached from the book block 100, the book block 100 can be removed from the transport clamp 11 in downward direction, with the book spine 101 pointing down. For removing the book block 100 from the transport clamp 11, the machine 1 is provided with a conveying device 15 by means of which the book block 100 is moved from the transport clamp 11 to the downstream conveying element 16.

The machine 1 comprises a first conveying means 17 which removes a processed book block 100 with a controlled movement from the transport clamp 11. The first conveying means 17 is provided for this with a set of pressing jaws 18, 18a which can be fitted with the aid of an adjustment element 19 onto the book block 100, in the area of the book spine 101. At least the pressing jaw 18a is driven movably in a first direction by the adjustment element 19, in the direction indicated by the double arrow 62. For the exemplary embodiment, each pressing jaw 18, 18a is respectively driven by an adjustment element 19. In the position shown in FIG. 2, the pressing jaws 18, 18a are in a waiting position. For gripping a book block 100, the pressing jaws 18, 18a are fitted from the side onto the front and back of the book block 100. As soon as the pressing jaws 18, 18a exert pressure onto the book spine 101 and hold it in place, the transport gripper 11 opens up. The pressing jaws 18, 18a are fixedly connected to a table 20 which can be height adjusted vertically up and down, with a shifting device 30, such as a pneumatic cylinder or a spindle drive, as indicated with the double arrow 61 drawn in beside the table 20. For the exemplary embodiment shown, the pressing jaws 18, 18a can be adjusted with the table in a second direction. The pressing jaws 18, 18a and the table 20 with the shifting device 30 jointly form the first conveying means 17 for the exemplary embodiment shown.

The table 20 comprises guide elements 31, positioned on guide rails 32 that are attached to the machine frame 29. When the table 20 is lowered, the pressing jaws 18, 18a with the clamped-in book block 100 also move downward. In this way, the book block 100 is removed from the transport clamp 11 in downward direction. The clamp part 22 of the transport clamp 11, which is fixed in the direction transverse to the removal direction, defines a fixed edge 23 that is independent of the book block thickness, along which the book block 100 is pulled from the transport clamp 11.

During its downward movement, the table 20 reaches a position where the book spine 101 hits the supporting surface 24, which is fixedly connected to a supporting device 25. This position can be the lower end position to which the table 20 can move. The supporting device 25 is embodied as a swiveling arm and is positioned so as to swivel around a fulcrum 26. Approximately at the instant when the pressing jaws 18, 18a detach themselves from the book block 100, the supporting device 25, driven by a drive 32, swivels in clockwise direction downward around the fulcrum 26. In the process and owing to gravity, the book block 100 remains positioned upright with the book spine 101 on the supporting surface 24 and follows the swiveling movement of the supporting device 25. The book block 100 is furthermore supported on the side by a curved slide, which furthermore guides the book block 100 on the side via its curved course. The slide here forms the deflection element 27. For the exemplary embodiment shown, the supporting device 25 and the slide jointly form the second conveying means 28.

For the exemplary embodiment shown, the supporting device 25 and the supporting surface 24 jointly carry out an approximately quarter-circle rotation until the book block 100 that rests on the supporting surface reaches the downstream-arranged conveying element 16. The slide with its curved course also describes approximately a quarter circle of 90°. During the course of the conveying section traveled by a book block 100 in the region of the second conveying means 28, the book block is deflected from an at least approximately vertical to an at least approximately horizontal position.

A drive 59 that is assigned to the supporting device 25 is embodied to move the supporting surface 24 at a slide end 38, as seen in conveying direction, with a movement speed that corresponds to at least the conveying speed of the conveying element 16 which follows the slide downstream in conveying direction. The supporting device 25 can rotate further with accelerated speed in conveying direction once the book block 100 reaches the end 38 of the slide and the region of transition to the following conveying element 16, so that the book block 100 can be conveyed away underneath the supporting device 25, without colliding with it. In that case, the drive 59 assigned to the supporting surface 24 is embodied to accelerate the movement speed of the supporting surface 24 in conveying direction, in the transition region from the slide end 38 to a downstream arranged conveying element 16, to a value that is higher than the movement speed of the conveying element 16 following in downstream direction.

The electronic control device 6 controls the movements of the drive 59 for the supporting device 25, but also those of the adjusting elements 19 for the pressing jaws 18, 18a and the shifting device 30 for moving the table 20, as well as the drives 58 for the transport clamps 11, 12, 13. The opening and closing of the transport clamps 11, 12, 13 can be cam-controlled, or can be controlled respectively by a non-depicted adjustment device that is also connected to the control device 6. The control device 6 comprises a software for synchronizing the time for positioning and/or opening of the transport clamps 11, 12, 13 in the region of the removal station 53 and the movements of the first conveying means 17 and the supporting device 25 of the second conveying means 28, such that the transport clamp 11, 12, 13 opens up only if the first conveying means 17 is fitted against the processed book block 100, such that the processed book block 100 is conveyed in a downward direction with the first conveying means 17 only if the transport clamp 11, 12, 13 is opened, and such that the first conveying means 17 detaches from the processed book block 100 only if the book block 100 has been deposited on the supporting device 25.

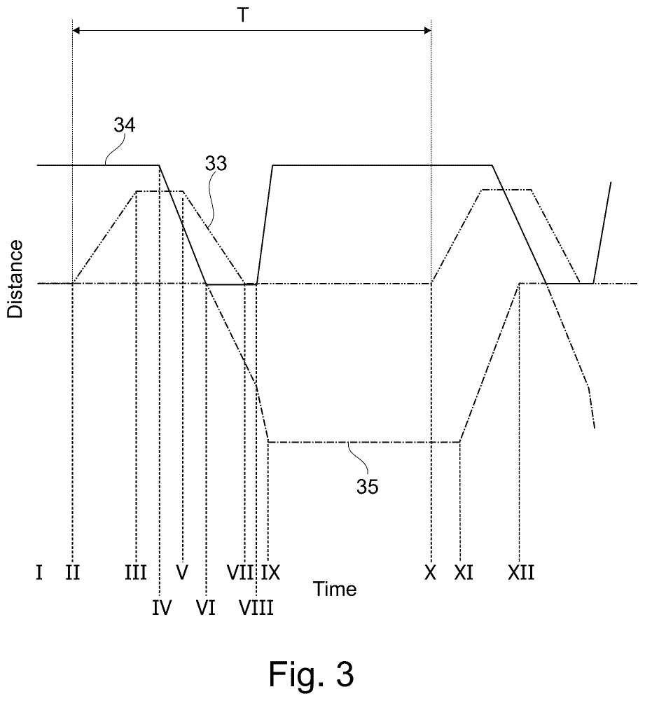

One option for controlling the timed sequences of these adjustment/shifting elements follows from the time/distance diagram shown in FIG. 3. In the time/distance diagram a curve 33 indicates the adjustment track for the pressing jaws 18, 18a with a dash-two dots line. A curve 34 shows the adjustment track for the table 20, and a curve 35 (dash-dot line) shows the adjustment track for the supporting shifting device 30 during the course of one operating cycle T of the machine.

In the position I entered on the X-axis, the pressing jaws 18, 18a are in the open waiting position and the table 20 as well as the supporting device 30 are in the upmost position.

In the position II, the starting point for an operating cycle, the pressing jaws 18, 18a start to close until they have reached a position III in which a book block 100 is clamped in.

Following this, the table 20 starts the downward movement in position IV where it takes along the pressing jaws 18, 18a with the clamped-in book block 100 in downward direction. The movable clamping part 14 of the transport clamps 11, 12, 13 opens up between the position III and IV, so that the table 20 can carry the book block 100 along in downward direction.

Even before the table 20 has reached its lowest point, in position VI, the pressing jaws 18, 18a start opening once more starting at position V, causing the grip with which the book block 100 is held by the pressing jaws 18, 18a to increasingly loosen up. In the position VI where the table 20 reaches its lowest point, the supporting device 25 simultaneously starts the swiveling movement in downward direction. At this position VI, the book spine 101 hits the supporting surface 24 of the supporting device 25. There the supporting device 25 accepts the book block 100, released by the pressing jaws 18, 18a, and conveys it downward. The uniform gradient of the curves 34, 35 in the region of the position VI shows that the table 20 and the supporting device 30 move at the same speed, thus permitting a soft transfer of the book block 100.

In the position VII where the supporting device 25 still continues its downward swiveling movement, the pressing jaws 18, 18a have reached their maximum opened position. Shortly thereafter, at position VIII, the table 20 starts to move back to its starting position with the aid of the shifting device 30. The control device 6 in this way is programmed to move the first conveying means 17 with the aid of the shifting device 30 back to the waiting position after the first conveying means 17 has deposited the book block 100 on the supporting device 25 and has detached itself from the processed book block 100. Approximately at the same time as the table 20 starts the return movement to its starting position, the supporting device 25 also reaches its maximum swiveling position. As can be seen by the kink in the curve 35 between the positions VII and IX, the swiveling movement of the supporting device 25 has accelerated toward its end, before reaching its maximum swiveling position at position IX. Approximately at the position IX, the table has again reached its starting position.

For the remaining time of the operating cycle, the supporting device 25 remains in the extreme swiveling position 40, shown in FIG. 2, so that the book block 100 can be conveyed out of its movement range with the aid of the following conveying element. The pressing jaws 18, 18a also remain in their maximum opened position, as the waiting position, until a new operating cycle begins at position X and the pressing jaws 18, 18a start closing again. With the new operating cycle starting at the position X, the above-described movement sequence starts anew, wherein the supporting device 25 now swivels back to its starting position, moving between the positions XI and XII. The control device 6 is thus programmed to move the supporting device 25 back to its starting position once a processed book block 100 has been released to a conveying means 16 that is arranged downstream of the second conveying means 28.

As can be seen in FIG. 2, a sensor 36 which is arranged in the area of the removal station 53 is connected to the control device 6 for monitoring the removal of the book block 100 from the transport clamp 11, 12, 13. If the sensor 36 reports a malfunction during the removal, the control device 6 can switch the machine 1 to “malfunction.” Another sensor 37 is connected to the control device 6 in the region of the conveying element 16, following in downstream conveying direction, which sensor monitors the conveying away of a respectively processed book block 100. The control device 6 switches the machine 1 to “malfunction” if the sensor 37 reports a faulty removal. A malfunction in the conveying operation can refer to a late arrival of the book block at the sensor 37. If the sensor 37 is embodied such that it can also check the position of a book block, then a slanted positioning of the book block on the conveying element can also result in a malfunction during the conveying away.

It will be understood that the above description of the present invention is susceptible to various modifications, changes and adaptations, and that the same are intended to be comprehended within the meaning and range of equivalents of the appended claims.

What is claimed is:

1. A machine for adhesive binding of book blocks, the machine comprising components as follows:
at least one processing station for processing a book block spine of one of the book blocks;
at least one further processing station for applying adhesive to the spine; a book block transport system including a transport clamp for transporting the book block through the machine, the book block transport system including:
an intake station for holding a non-bound book block inside the transport clamp with an approximately vertical orientation; and
a removal station including a conveying device for removing the processed book block from the transport clamp with a controlled movement over a course of a conveying section during which an orientation of the processed book block is changed from the approximately vertical orientation to an approximately horizontal orientation, wherein the conveying device comprises:
a first conveying means for removing with a controlled movement the processed book block from the transport clamp; and
a second conveying means, following downstream of the first conveying means, which includes a deflection element and a swivel-driven supporting device for taking over the processed book block from the first conveying means while deflecting the book block from the approximately vertical orientation to an approximately horizontal orientation, and transferring the approximately horizontally oriented book block to a downstream conveying element; and
an electronic control device programmed and connected for controlling at least the above recited functionality of the foregoing machine components.

2. The machine according to claim 1, wherein: the first conveying means includes:
a pair of pressing jaws arranged on opposite sides of the processed book block in a waiting position when the book block is conveyed into the removal station, wherein at least one of the pressing jaws is drivable in a first direction in the removal station from the waiting position to a position against a side of the processed book block facing the one pressing jaw for holding the processed book in an area of the spine between the pair of pressing jaws; and
a shifting device for moving the pressing jaws in a second direction to convey the book block downwardly away from the transport clamp while clamped into the pressing jaws.

3. The machine according to claim 2, wherein a pressure exerted by the pair of drivable pressing jaws onto the side of the book block is adjustable in the first direction from book block to book block.

4. The machine according to claim 2, wherein the pressing jaws have a length that extends over a complete spinal length of the processed book block.

5. The machine according to claim 2, wherein the shifting device includes a table which is adjustable in the vertical direction and the pressing jaws are fixedly connected to the table.

6. The machine according to claim 5, further including guide rails attached to the machine frame, wherein the table comprises guide elements which area positioned in the guide rails that are attached to a machine frame.

7. The machine according to claim 1, wherein the deflection element comprises a curved slide which changes from an at least approximately vertical course to an at least approximately horizontal course, as seen in conveying direction.

8. The machine according to claim 7, wherein the swivel-driven supporting device comprises a supporting surface that carries out a swiveling movement during an operating cycle which follows a course of the curved slide, as a result of which the book spine of the processed book block is held at least partially supported during passage of the second conveying means.

9. The machine according to claim 8, wherein the movement of the pressing jaws in the second direction is controlled by the control device to deposit the processed book block onto the supporting surface of the supporting device and the supporting surface of the supporting device is oriented parallel to a surface of the book spine of the processed book block when the processed book block is deposited by the pressing jaws onto the supporting surface.

10. The machine according to claim 9, wherein the movement of the pressing jaws in the second direction is controlled by the control device so that the book spine of the processed book block is deposited with a jolt onto the supporting surface.

11. The machine according to claim 8, wherein the supporting device is connected via a swiveling arm to a fulcrum and the supporting surface carries out a circular-arc swiveling movement.

12. The machine according to claim 8, further including a drive assigned to the supporting device and designed to move the supporting surface at an end of the slide, as seen in conveying direction, with a speed in conveying direction which corresponds at least to the conveying speed of a conveying element arranged downstream of the slide in the conveying direction.

13. The machine according to claim 12, wherein the drive assigned to the supporting surface is designed to accelerate a movement speed in an area of transition from the end of the slide end to a following conveying element, as seen in conveying direction, to a value that is higher than a movement speed of the conveying element following in conveying direction.

14. The machine according to claim 1, wherein an opening of the transport clamp in a region of the removal station and movements of the first conveying means and the supporting device are coordinated in time via the control device, such that the transport clamp opens up only once the first conveying means has been fitted against the processed book block, wherein the conveying away of the processed book block with the first conveying means in downward direction occurs only once the transport clamp is opened, and that the first conveying means detaches itself from the processed book block only once the book block has been deposited on the supporting device.

15. The machine according to claim 1, further including a sensor arranged in a region of the removal station and connected to the control device for monitoring a removal of the book block from the transport clamp, wherein the control device switches the machine to “malfunction” if the sensor detects a faulty removal.

16. The machine according to claim 7, further comprising a sensor connected to the control device and located in one of a transition region from the end of the deflection element, as seen in conveying direction to a conveying element following downstream in conveying direction, or located in a region of the downstream conveying element, which sensor monitors the conveying away of a respectively processed book block, and wherein the control device switches the machine to “malfunction” if the sensor reports a faulty removal.

17. The machine according to claim 2, wherein the control device is programmed to move the first conveying means with the aid of the shifting device back to the waiting position after the first conveying means has deposited the book block onto the supporting device and has detached itself from the processed book block.

18. The machine according to claim 1, wherein the control device is programmed to move the supporting device back to its starting position once a processed book block has been transferred to the downstream conveying element which follows the second conveying means.

19. The machine according to claim 2, wherein a pressure exerted by the pair of drivable pressing jaws onto the side of the processed book block is adjustable during movement in the second direction.
